(19) United States
(12) Patent Application Publication
(10) Pub. No.: US 2026/0254627 A1
(43) Pub. Date: Aug. 27, 2026

(54) Using Different Sets Of Biometric Data Extracted From A User To Generate A Same Cryptographic Key For Temporary Storage And Use

(71) Applicant: Oracle International Corporation, Redwood Shores, CA (US)

(72) Inventors: Matías Brutti, Seattle, WA (US); Heather Marie Huggins, Thousand Oaks, CA (US)

(73) Assignee: Oracle International Corporation, Redwood Shores, CA (US)

(21) Appl. No.: 19/061,109

(22) Filed: Feb. 24, 2025

(51) Int. Cl. H04L 9/08

(52) U.S. Cl. CPC H04L 9/0866

(57) ABSTRACT

A system generates reproducible cryptographic keys by extracting biometric data on multiple devices. The system applies a biometric-key process to extracted biometric data, transforming the biometric data into cryptographic keys for executing cryptographic operations. The system extracts a first set of biometric data on a first device to create a first instance of a reproducible cryptographic key through the biometric-key process. The system executes a first cryptographic operation on the first device using the first instance of the reproducible cryptographic key. The system extracts a second set of biometric data on a second device (which may be the first device) to generate a second instance of the reproducible cryptographic key through the biometric-key process. The system executes a second cryptographic operation on the second device using the second instance of the reproducible cryptographic key

### TECHNICAL FIELD

The present disclosure relates to biometric identity systems.

### BACKGROUND

Biometric identity systems facilitate access control through the processing of distinctive physiological characteristics unique to individual users. These systems typically operate by conducting precise measurements and analyses of various physiological attributes, including fingerprints, facial features, iris patterns, and voice characteristics. Initially, when authentication is attempted, specialized sensors capture raw biometric data from the user. This collected data undergoes transformation into digital feature vectors that represent the distinguishing elements of the presented biometric sample. Subsequently, the system executes a comparison between these vectors and previously stored reference templates that were established during the user's initial enrollment phase.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a biometric identity system in accordance with one or more embodiments;

FIGS. 2A and 2B illustrate an example set of operations for biometric identity in accordance with one or more embodiments;

FIG. 3 illustrates exemplary biometric identity operations in accordance with one or more embodiments; and

FIG. 4 shows a block diagram that illustrates a system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. BIOMETRIC IDENTITY SYSTEM ARCHITECTURE
3. BIOMETRIC IDENTITY OPERATION
4. EXAMPLARY BIOMETRIC IDENTITY OPERATION USING REGENERATED PRIVATE KEYS
5. PRACTICAL APPLICATIONS, ADVANTAGES & IMPROVEMENTS
6. MISCELLANEOUS; EXTENSIONS
7. HARDWARE OVERVIEW

### 1. General Overview

One or more embodiments generate the same reproducible cryptographic key based on different sets of biometric data extracted from a user. A system extracts biometric data from a user to create a reproducible cryptographic key through a biometric-key process that produces consistent cryptographic keys despite variations in captured biometric data. The reproducible nature of the cryptographic key enables seamless authentication without requiring storage of the original biometric data or keys on any device. The system enhances security by generating identical keys from distinct biometric captures. The biometric-key process transforms natural variations in biometric captures into stable cryptographic keys, providing consistent authentication while accommodating inherent differences in biometric measurements across different sensors and environmental conditions.

One or more embodiments extract user-specific feature vectors through transformation of raw biometric inputs. The system applies fuzzy extraction processes to biometric data to generate consistent user-specific feature vectors. The user-specific feature vectors are consistent when generated from different biometric data sets of the same user. The extraction ensures generation of identical feature vectors despite variations in the raw biometric inputs for the user. After execution of operations, biometric data sets, feature vectors, and private keys need not be stored on the system for later use as they processes may be repeated to generate the same cryptographic keys. The system increases security by reducing the amount of time that the biometric data, feature vectors, and keys are stored and thus potentially accessible.

One or more embodiments ensure security through deletion of sensitive data. The system removes biometric data from memory upon completion of feature vector generation, eliminates generated feature vectors after cryptographic key creation, and erases cryptographic keys following operation execution. In an example, the system avoids writing such sensitive information to persistent storage. The system regenerates the cryptographic keys from biometric data when needed.

One or more embodiments generate a public and private key during initial enrollment using extracted biometric data and later regenerates a matching private key during subsequent authentication attempts through new biometric data extraction. Through the regeneration processes, the system maintains authentication capabilities without storing private keys. The system signs authentication messages using the regenerated private keys. The system utilizes the user-specific feature for a reproducible, deterministic or non-deterministic, key generation process, such as in elliptic curve cryptography.

One or more embodiments described in this Specification and/or recited in the claims may not be included in this General Overview section.

### 2. Biometric Identity System Architecture

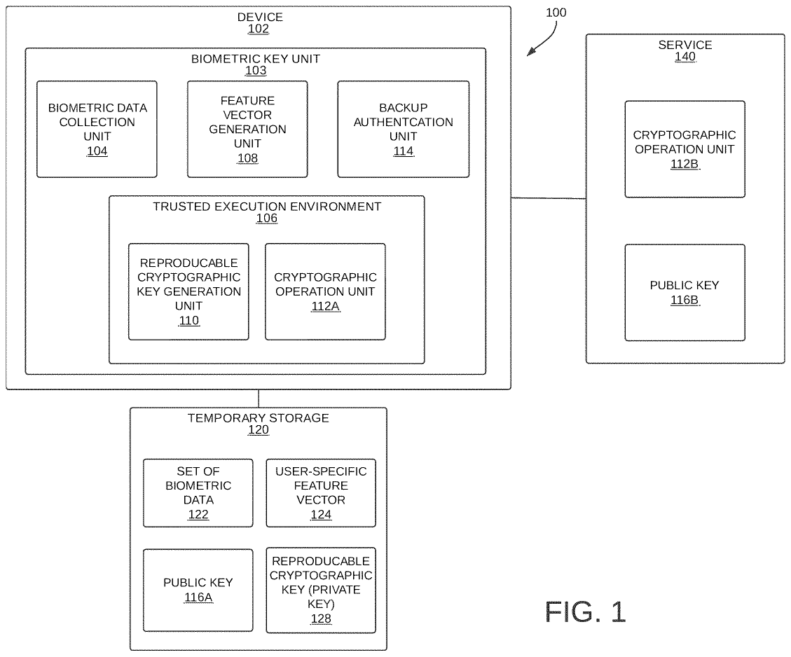

FIG. 1 illustrates a biometric identity system in accordance with one or more embodiments. System 100 generates reproducible cryptographic keys through biometric data extraction without persistent storage of the cryptographic keys or biometric data.

As illustrated in FIG. 1, system 100 comprises device 102, biometric key unit 103, service 140, trusted execution environment 106, temporary storage 120, biometric data collection unit 104, feature vector generation unit 108, reproducible cryptographic key generation unit 110, cryptographic operation units 112A and 112B, backup authentication unit 114, public keys 116A and 116B, sets of biometric data 122, user-specific feature vectors 124, and reproducible cryptographic keys private key 128 for providing secure biometric authentication services. In one or more embodiments, system 100 may include more components or fewer components than the components illustrated in FIG. 1.

In an embodiment, device 102 is a hardware device, such as a desktop computer, computer system, handheld device (such as a phone), networking device, or any other device that incorporates hard-wired and/or program logic to implement the techniques discussed below. Device 102 provides secure biometric authentication capabilities. Device 102 integrates with biometric sensors for data capture operations. Device 102 includes protected memory regions for sensitive data processing. Device 102 coordinates authentication operations through secure interfaces. Device 102 maintains security boundaries between processing environments.

In an embodiment, biometric key unit 103 implements a biometric-key process to generate keys for the system. Biometric key unit 103 extracts biometric data from a user to create a reproducible cryptographic key through a biometric-key process that produces consistent cryptographic keys despite variations in captured biometric data. The reproducible nature of the cryptographic key enables seamless authentication without requiring storage of the original biometric data or keys on any device. Biometric key unit 103 enhances security by generating identical keys from distinct biometric captures, eliminating the need to synchronize or transfer sensitive key material between devices. Biometric key unit 103 transforms natural variations in biometric captures into stable cryptographic keys, providing consistent authentication while accommodating inherent differences in biometric measurements across different sensors and environmental conditions.

In an embodiment, biometric data collection unit 104 captures biometric data, such as set of biometric data 122, through a sensor, such as a camera, microphone, or fingerprint detector. The collected biometric data may concern fingerprints, facial features, iris patterns, voice characteristics, or any other type of biometric feature.

In an embodiment, feature vector generation unit 108 transforms biometric data into user-specific feature vector 124. Biometric data is converted into digital templates through a process that starts with preprocessing, where a raw scan is enhanced for clarity by removing noise and adjusting contrast to make features more distinct. The system then moves to feature extraction, identifying specific unique points in the biometric data. For fingerprints, these are called “minutiae points” and include ridge endings (where a line stops), ridge bifurcations (where a line splits in two), ridge direction and curvature, and core points. This data undergoes template creation where these features are converted into numerical coordinates and angles, followed by data reduction that reduces the size of the information, for example, reducing a 250 KB fingerprint image to a 1 KB template while retaining essential identifying features.

In an embodiment, feature vector generation unit 108 further transforms the template into a user-specific feature vector 124. For example, feature vector generation unit 108 uses a fuzzy extraction process. For fuzzy extraction, feature vector generation unit 108 converts slightly different biometric data into the same value such as the user-specific feature vector 124. In one example, feature vector generation unit 108 takes the initial biometric template and generates user-specific feature vector 124 and a helper string with error-correction information. In one example, the helper string is made public and shared between devices without affecting security. In a reproduction phase, feature vector generation unit 108 takes a new biometric scan and produces a modified template. Feature vector generation unit 108 uses the helper string to correct minor variations and reconstruct user-specific feature vector 124. Alternatively, feature vector generation unit 108 constructs and reconstructs user-specific feature vector 124 without a helper string or with the use of a standard helper string.

In an embodiment, trusted execution environment 106 provides isolated processing capabilities for sensitive operations. Trusted execution environment 106 is a secure, isolated area within a main processor that executes in parallel with the operating system, providing a protected space where sensitive data is stored and processed without risk of being accessed or modified by other software, including the operating system itself. Trusted execution environment 106 operates with its own memory and storage space, executes with a separate operating system (known as a secure OS), and uses hardware-level isolation to ensure that even if the main system is compromised, the protected data and operations remain secure. Trusted execution environment 106 executes reproducible cryptographic key generation unit 110, and, optionally, feature vector generation unit 108.

In an embodiment, reproducible cryptographic key generation unit 110 creates authentication credentials from user-specific feature vector 124. Reproducible cryptographic key generation unit 110 applies a deterministic or non deterministic algorithm for key derivation. Reproducible cryptographic key generation unit 110 creates public and private key pairs such as through elliptic-curve cryptography (ECC).

In an embodiment, reproducible cryptographic key generation unit 110 uses user-specific feature vector 124 to generate public key 116A and 116B and the private key 128. Device 102 uses user-specific feature vector 124 to derive the private key. Since feature vector generation unit 108 regenerates user-specific feature vector 124 from biometric data, reproducible cryptographic key generation unit 110 is able to regenerate generate public key 116A and 116B as well as the private key 128.

In an embodiment, cryptographic operation unit 112A performs signing operations using private key 128. Cryptographic operation unit 112A signs messages with private key 128. Cryptographic operation unit 112A hashes the message using a cryptographic function like SHA-256. Cryptographic operation unit 112A then encrypts this hash using private key 128 to create the signature. The message and signature are sent together, allowing the recipient to decrypt the signature using the sender's public key to retrieve the original hash.

In an embodiment, backup authentication unit 114 provides alternative access mechanisms such as a password sign-in system. Backup authentication unit 114 maintains security requirements during fallback operations and ensures authorized access through additional factors. Backup authentication unit 114 coordinates with primary authentication systems.

In an embodiment, temporary storage 120 holds transient authentication data during processing operations. In one example, temporary storage 120 exists in volatile memory regions. Alternatively, the temporary storage implements secure deletion mechanisms after use. Temporary storage 120 prevents persistent storage of sensitive materials. Temporary storage 120 stores sets of biometric data 122, user-specific feature vectors 124, and reproducible cryptographic keys 128 that are deleted after use.

In an embodiment, service 140 enables devices, like phones, to perform functions beyond their local capabilities. Service 140 is any type of service or remote server, such as cloud storage for backing up photos and files, authentication servers for account verification, push notification servers to deliver alerts, mapping/location services for navigation, app stores for software distribution, and messaging servers for communication.

In an embodiment, service 140 stores public key 116B associated with a registered user of device 102. Cryptographic unit 110 at service 140 generates public key 116A and makes a copy, public key 116B, freely available. Service 140 receives a message from device 102, including the signature, the signed hash. Cryptographic unit 110 independently hashes the received message and uses public key 116B to decrypt the signature. Cryptographic unit 110 compares the hash to the decrypted signature. If the decrypted signature matches the newly calculated hash, this proves the message was signed by the corresponding private key and has not been modified.

In one or more embodiments, device 102, service 140, trusted execution environment 106, biometric key unit 103, temporary storage 120, biometric data collection unit 104, feature vector generation unit 108, reproducible cryptographic key generation unit 110, cryptographic operation units 112A and 112B, and backup authentication unit 114 refer to hardware and/or software configured to perform operations described herein for information storage and retrieval.

In an embodiment, service 140, biometric key unit 103, trusted execution environment 106, biometric data collection unit 104, feature vector generation unit 108, reproducible cryptographic key generation unit 110, cryptographic operation units 112A and 112B, backup authentication unit 114, public keys 116A and 116B, sets of biometric data 122, user-specific feature vectors 124, and reproducible cryptographic keys private key 128 are implemented and/or stored on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. Biometric Identity Operation

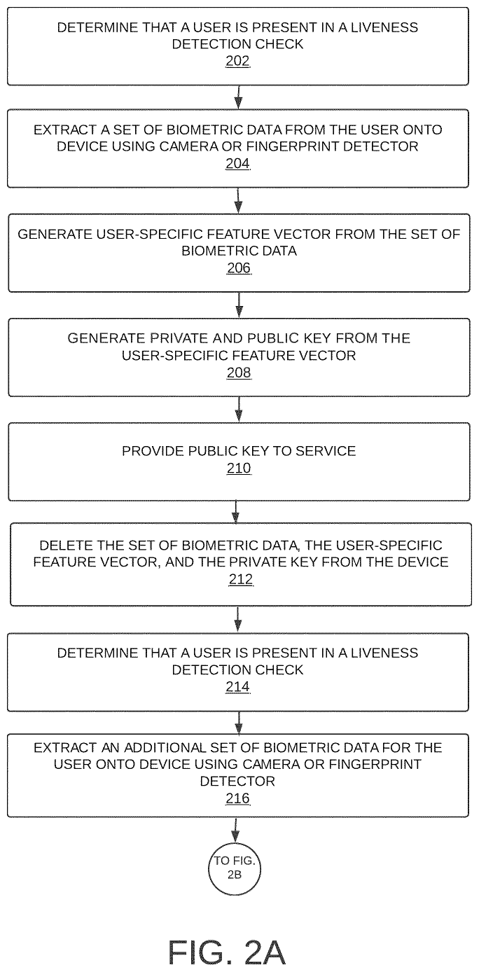

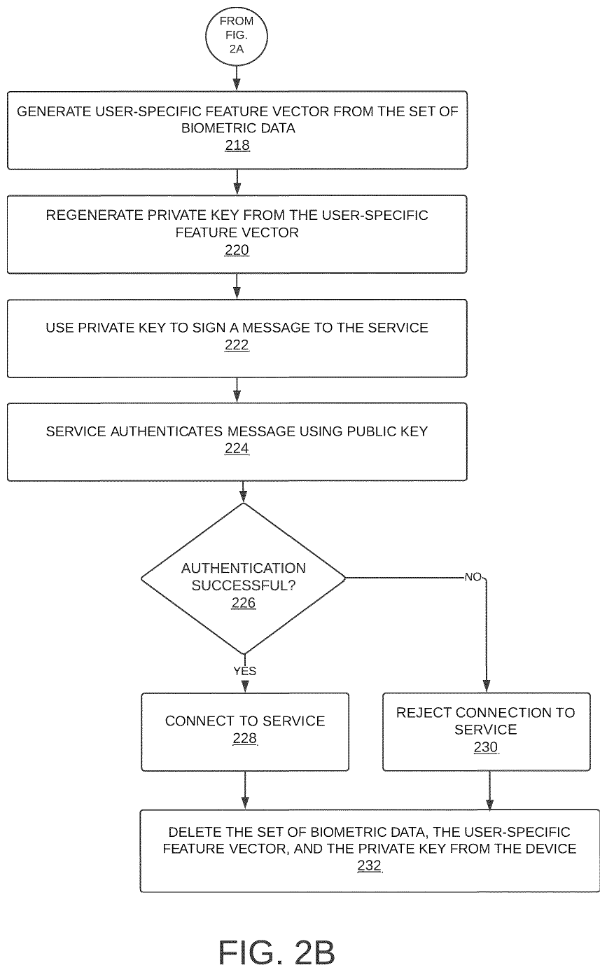

FIGS. 2A and 2B illustrate an example set of operations for biometric identity in accordance with one or more embodiments. One or more operations illustrated in FIGS. 2A and 2B may be modified, rearranged, or omitted. Accordingly, the particular sequence of operations illustrated in FIGS. 2A and 2B should not be construed as limiting the scope of one or more embodiments.

In an embodiment, a biometric authentication system generates cryptographic keys from captured biometric data without storing private keys or templates. Stored biometric data and private keys are the subject of data theft and are a security risk. The biometric authentication system generates cryptographic keys on the fly from biometric data without requiring storage of sensitive information. The system generates reproducible cryptographic keys through multiple extractions of different biometric data sets from users and does not rely on stored private keys or biometric data.

Looking at FIG. 2A, in an embodiment, a liveness detection check determines user presence before any biometric data extraction (Operation 202). The liveness detection check prevents spoofed biometric data by verifying physical presence of users such as with movement detection. Liveness detection verifies that a biometric sample comes from a living person physically present, not a photo, video, mask, or artificial replica. Exemplary liveness detection methods include detecting natural eye movements/blinking, face muscle micro-movements, skin texture analysis, and infrared scanning for blood flow patterns. In one example, the system also checks for natural responses to random prompts, like head turns or expressions. The liveness detection prevents replay attacks. In this way, the system validates biometric inputs that represent genuine users rather than recordings or simulations. The verification occurs before key generation to maintain security properties.

In an embodiment, the system extracts biometric data from users onto devices through cameras or fingerprint detectors (Operation 204). The system process captures facial features or fingerprint patterns using a sensor, such as a camera or a fingerprint scanner. The system converts physical characteristics into digital representations.

In an embodiment, the system extracts facial features from input images through detection of mathematical relationships between facial landmarks. The system generates multi-dimensional feature vectors representing spatial distances between detected eye corners, nose tip position, mouth corners, and jawline curvature. The system applies transforms to normalize extracted features based on head pose angles and lighting conditions.

In an embodiment, the system processes fingerprint images to identify minutiae points where ridge lines terminate or bifurcate. The system calculates angular relationships and relative positions between minutiae points to create distinctive fingerprint templates.

In an embodiment, the system captures iris patterns by segmenting the eye region into discrete zones. The system maps textures and structures within the iris to generate binary encodings representing unique features. The system normalizes iris codes to account for pupil dilation and environmental lighting variations during capture.

In an embodiment, the system records voice characteristics by sampling audio input and extracting frequency components through signal processing. The system generates voiceprints based on vocal tract resonances, fundamental frequency ranges, and temporal patterns in speech. The system creates voice templates resilient to background noise and voice stress variations.

In an embodiment, the system generates user-specific feature vectors from the extracted biometric data sets (Operation 206). The feature vector generation process transforms raw biometric inputs into mathematical representations through specialized algorithms. The transformation preserves distinctive characteristics while removing irrelevant variations. The system applies dimension reduction techniques to create compact representations. The generated vectors enable consistent authentication across multiple sessions. The feature vectors generate reproducible cryptographic keys used for authentication while preserving privacy by deleting both biometric data and keys after use.

In an embodiment, the system transforms raw biometric input into mathematical representations through feature extraction algorithms to produce the user-specific feature vectors. The system applies fuzzy extraction algorithms to ensure consistent regeneration of cryptographic outputs despite variations in captured biometric data. The system adjusts fuzzy extraction parameters based on likelihood of feature changes in users. Fuzzy extraction converts inconsistent biometric measurements into stable, user-specific feature vectors. The system generates a key and helper data during enrollment. During verification, the system uses similar but not identical biometric samples to reconstruct the same user-specific feature vector (and thus private key) using the helper data while keeping the original biometric data private. The error correction accommodates natural variations in biometric readings while maintaining cryptographic security properties. The fuzzy extraction process accommodates expected variations in biometric measurements while maintaining sufficient uniqueness to generate secure keys.

In an embodiment, the system takes the initial biometric template and generates a user-specific feature vector and a helper string with error-correction information. In one example, the helper string is made public and shared between devices without affecting security. In a reproduction phase, the system takes a new biometric scan and produces a template that may be different from the original template. The system uses the helper string to correct minor variations and reconstruct user-specific feature vectors.

In an embodiment, the system refines biometric data through extraction of stable facial characteristics. The system identifies facial features demonstrating temporal consistency. The system generates feature vectors emphasizing persistent biometric markers. The system selects features resistant to aging and environmental variations. In one example, the system processes facial features to identify stable characteristics, like bone structure ratios, while discounting variable elements like hairstyles. The extraction creates normalized feature vectors that produce matching cryptographic keys despite superficial changes in appearance.

In an embodiment, the system incorporates machine learning models for robust biometric feature extraction. The system trains neural networks on diverse biometric samples to learn stable feature representations. The system optimizes feature extraction through supervised learning on matched biometric pairs. The system develops models resistant to environmental variations and aging effects.

In an embodiment, the system builds training datasets from historical biometric processing. The system collects temporally separated biometric samples from users. The system annotates sample pairs to indicate matching identities. The system learns mappings between raw biometrics and stable feature spaces using the historical biometric data.

In an embodiment, the system generates private and public cryptographic keys from user-specific feature vectors (Operation 208). The key generation process applies cryptographic functions to feature vectors for creating secure authentication credentials. The system uses a reproducible (deterministic or non-deterministic) algorithm to ensure reproducibility of keys from similar biometric inputs. The resulting keys provide strong cryptographic properties while maintaining ties to original biometric data. The system executes cryptographic operations within isolated secure enclaves or trusted execution environments.

In an embodiment, the system uses ECC. Elliptic-curve cryptography is a public-key cryptography approach based on the algebraic structure of elliptic curves over finite fields, where the security is derived from the mathematical difficulty of solving the elliptic curve discrete logarithm problem. A seed value gets mapped to a point on a carefully chosen elliptic curve, such as the NIST P-256 curve defined by the equation y²=x³+ax+b (where a and b are curve-specific constants). From this initial point, scalar multiplication is used to generate additional points along the curve that form the basis of the key pair. The private key is large integer, while the public key is the result of multiplying this private key with the curve's generator point. The scalar (private key) is smaller than the curve's order n (the number of points in a subgroup). For common curves like secp256k1, the scalar is 256 bits.

In an embodiment, a key generation system creates elliptic curve key pairs using the user-specific feature vector. The system leverages curves, including Curve25519, to produce secure, efficient keys suitable for mobile applications. The system regenerates private keys on-demand through fresh biometric scans rather than storing persistent values. The system implements reproducible key generation processes using user-specific feature vectors. The system maintains reproducibility through standardized elliptic curve cryptography procedures. In an example, the system hashes the user-specific feature vector into the range of the private key of the cryptographic system such as 256 bits. Alternatively, the user-specific feature vector is restricted to be in the range of the private key of the cryptographic system during construction of the user-specific feature vector.

In an embodiment, the system provides a public key to a service for subsequent authentication (Operation 210). The public key transmission enables services to verify future authentication attempts without requiring storage of sensitive biometric data. The system establishes secure channels for key distribution to prevent tampering. In one example, public keys are stored in digital certificates with key data and metadata about the user. The certificates are signed by Certificate Authorities (CAs) and distributed through Public Key Infrastructure (PKI). Organizations maintain key servers that publish and distribute public keys, while web browsers and operating systems store trusted root CA certificates locally. In one example, the certificates follow the X.509 standard format encoding key data along with validity periods, serial numbers, and issuer information.

In an embodiment, the system deletes biometric data, feature vectors, and private keys from devices after key generation (Operation 212). The deletion process ensures sensitive authentication data remains unrecoverable from device storage. In an example, the deletion is responsive at least to determining that execution of the first cryptographic operation is complete. The system overwrites memory locations with sensitive data multiple times. The deletion extends to temporary storage areas and cache memories. The process verifies complete removal of sensitive data through memory scans. Alternately, biometric data and private keys are never transferred from temporary to permanent memory. The system thus implements authentication without requiring stored templates or keys on devices. Users register by generating a public key from biometric measurements and providing the public key to authentication servers. Subsequent authentication regenerates matching private keys through new biometric measurements without accessing stored data. The keys enable standard public key cryptographic operations.

In an embodiment, the system implements secure memory management for biometric processing. The system stores biometric data, feature vectors, and cryptographic keys exclusively in volatile memory. The system prevents writing of sensitive biometric information to persistent storage locations. The system removes cryptographic keys from memory after completing required operations.

In an embodiment, the system enforces strict data lifecycle management during biometric processing. The system deletes original biometric samples immediately after feature extraction. The system removes intermediate data products, including feature vectors, after key generation. The system clears cryptographic keys from device memory once operations complete. In an embodiment, the system removes raw biometric data before proceeding with feature extraction. The system deletes feature vectors prior to key generation phases. The system clears generated keys before executing cryptographic operations.

In one embodiment, the system deletes biometric data from the device responsive to one of a number of conditions. In one example, the conditions include one or more of determining that the user-specific feature vector has been generated from the set of biometric data, determining that the cryptographic key has been generated from the user-specific feature vector, or an operation using the cryptographic key has been executed.

In one embodiment, the system deletes biometric data from the device prior to one of a number of conditions. In one example, the conditions include one or more of generating the user-specific feature vector from the set of biometric data, generating the cryptographic key from the user-specific feature vector, or executing an operation using the cryptographic key.

In an embodiment, the system performs another liveness detection check before subsequent authentication attempts (Operation 214). The secondary check maintains security by verifying continued physical presence as discussed with respect to operation 202.

In an embodiment, the system extracts additional biometric data sets through cameras or fingerprint detectors (Operation 216). The repeated extraction enables authentication through fresh biometric samples. The system applies consistent capture parameters across sessions as discussed with respect to operation 204. The second extraction of biometric data and later operation may be done at the same or a different device as the operations above.

Moving to FIG. 2B, in an embodiment, the system generates a new feature vector from additional biometric data sets (Operation 218). The regeneration process creates a user-specific feature vector matching the previous user-specific feature vector despite variations in raw biometric inputs. The system applies normalization techniques to handle input variations. The vector generation maintains consistency through standardized processing steps as discussed with respect to operation 204.

In an embodiment, the system regenerates a private key from the regenerated user-specific feature vector (Operation 220). The key regeneration reproduces original cryptographic credentials through a reproducible process. The system applies consistent transformation functions across sessions. The regeneration process maintains cryptographic strength requirements. The resulting keys enable seamless authentication experiences. The system regenerates private keys through fresh biometric capture on client devices. The system achieves consistent key regeneration despite differences between captured biometric data sets since the fuzzy extraction of operations 206 and 218 produce the same user-specific feature vectors.

In an embodiment, the system signs messages to services using regenerated private keys (Operation 222). The signing process proves possession of valid authentication credentials. The system generates cryptographic proofs through standard signature schemes. The signatures incorporate timestamps and challenge responses. The signing operations occur within secure processing environments.

In an embodiment, the system performs signing operations using the private key. The system hashes the message using a cryptographic function such as SHA-256. The system then encrypts this hash using the private key to create the signature. The message and signature are sent together, allowing the recipient to decrypt the signature using the sender's public key to retrieve the original hash.

In an embodiment, services authenticate signed messages using stored public keys (Operation 224). The service receives the message from a device that includes the signature, the signed hash. The service rehashes the received message and also uses the public key to decrypt the signature. The service compares the hash to the decrypted signature. If the decrypted signature matches the newly calculated hash, this proves the message was signed by the corresponding private key and has not been modified.

In an embodiment, the service determines if authentication was successful (Operation 226). For example, if the decrypted signature matches the newly calculated hash, authentication was successful. If the decrypted signature does not match the newly calculated hash, authentication was not successful.

In an embodiment, successful authentication establishes service connections (Operation 228). The connection process grants access to authorized users based on cryptographic verification. The system establishes secure communication channels for authenticated sessions.

In an embodiment, authentication failures result in service connection rejections (Operation 230). The rejection process prevents unauthorized access attempts. The system logs failed authentication attempts for security analysis. The rejection mechanisms implement progressive delays to prevent brute force attacks. The system notifies administrators of suspicious authentication patterns.

In an embodiment, the system deletes additional biometric data, feature vector, and regenerated private key (Operation 232) similarly to operation 212. The deletion maintains security by removing sensitive authentication data from devices. The security mechanisms prevent recovery of sensitive authentication material.

In an embodiment, the system integrates with existing authentication frameworks, like passkeys, while adding improved security and privacy. Services receive just the public keys and remain unaware whether private keys derive from stored data or biometric regeneration. The approach maintains compatibility with current protocols while eliminating risks from stored credentials.

### 4. EXAMPLARY BIOMETRIC IDENTITY OPERATION USING REGENERATED PRIVATE KEYS

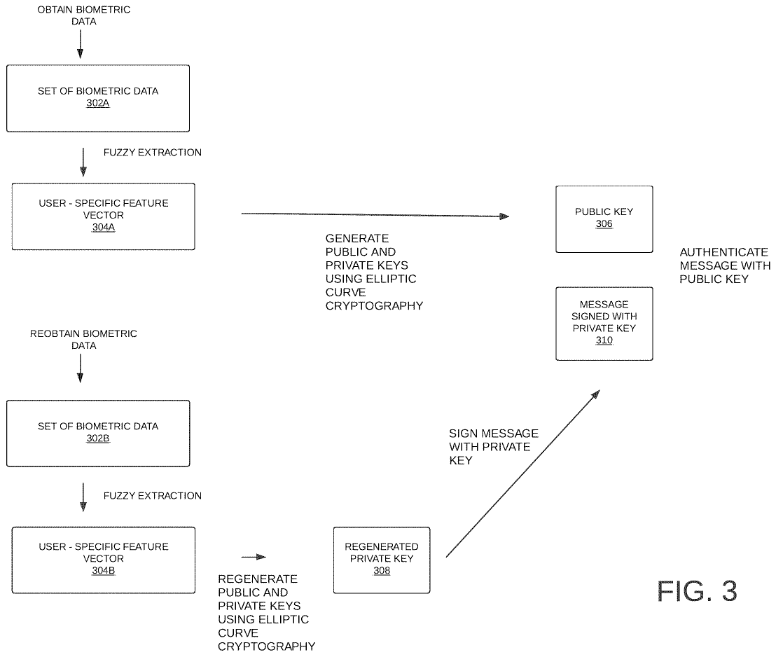

FIG. 3 illustrates exemplary biometric identity operations in accordance with one or more embodiments. The exemplary biometric identity operations of FIG. 3 are merely illustrative and may be modified, rearranged, or omitted. Accordingly, the exemplary biometric identity operations illustrated in FIG. 3 should not be construed as limiting the scope of one or more embodiments.

In an embodiment, the system obtains biometric data through capture devices to create biometric data 302A. The system applies standardized capture parameters to ensure consistency across sessions. The acquisition phase implements liveness detection to prevent spoofing attempts. The capture mechanisms adapt to environmental conditions while maintaining data consistency.

In an embodiment, the system generates user-specific feature vector 304A through fuzzy extraction processes. The extraction transforms raw biometric data into mathematical representations. The system applies noise reduction techniques to enhance feature stability. The transformation preserves essential characteristics while removing variations. The resulting user-specific feature vector provides a consistent basis for key generation.

In an embodiment, a biometric template extraction system transforms raw biometric input into mathematical representations through feature extraction algorithms. The system applies fuzzy extraction algorithms to ensure consistent regeneration of cryptographic outputs despite variations in captured biometric data. The system enables authentication across multiple devices using hardware capable of reproducing reliable biometric data.

In an embodiment, the system creates public key 306 through ECC operations. The generation process uses feature vectors for key derivation. The system applies reproducible algorithms to ensure reproducibility of generated keys.

In an embodiment, the system creates elliptic curve key pairs using extracted biometric templates as seed values to produce the private key. The system leverages curves, such as Curve25519, to produce secure, efficient keys. As discussed below, the system regenerates private keys on-demand through fresh biometric scans rather than storing persistent values.

In an embodiment, a registration system captures initial biometric scans to generate foundational templates for key derivation. The system transmits public keys with associated metadata to authentication servers. The system stores received public keys in server databases linked to user accounts. In an embodiment, a secure storage system maintains databases of public keys associated with registered users on authentication servers. The system generates random challenges during login attempts to prevent replay attacks. The system validates digitally signed challenges using stored public keys to verify user identities.

In an embodiment, the system captures a set of biometric data 302B through a subsequent authentication attempt. The capture process maintains consistency with initial acquisition parameters. The system implements fresh liveness detection for security assurance. The acquisition mechanisms compensate for environmental variations. The capture system ensures data quality meets authentication requirements. The set of biometric data 302B will typically be slightly different from the set of biometric data 302A.

In an embodiment, the system produces a user-specific feature vector 304B through the fuzzy extraction processes. The user-specific feature vector 304B matches user-specific feature vector 304A. The regeneration process compensates for minor variations of user-specific feature vector 304B from user-specific feature vector 304A. This results in reliable key regeneration.

In an embodiment, the system eliminates risks from stored authentication credentials through real-time key generation. Users authenticate from any compatible device without synchronizing or transferring sensitive data. The architecture prevents credential theft through device compromise since devices store no persistent authentication material.

In an embodiment, the system regenerates the public key and its associated private key 308 through ECC operations. The regeneration process uses user-specific feature vector 304B for key regeneration.

In an embodiment, an authentication system issues random challenge values to client devices during login attempts. The system regenerates private keys through fresh biometric capture on client devices. The system signs server challenges using regenerated private keys. The system verifies signatures using stored public keys to authenticate users.

In an embodiment, the system creates signed messages 310 using regenerated private key 308 for service authentication. The system hashes the message and signs the hash to create a signature sent along with the message. The receiving device or service rehashes the message and uses the public key 306 to create a hash that is compared with the sent signature.

In an embodiment, a key management system enables revocation of compromised credentials without requiring storage of private keys or templates. The system supports credential regeneration through fresh biometric acquisition. The system maintains security through elimination of stored sensitive data, surpassing existing solutions requiring local storage of biometric information. The system provides backup authentication methods through PINs or passwords for cases where biometric authentication fails.

### 5. Practical Applications, Advantages, & Improvements

The disclosed technology provides technical improvements to computer network security through real-time, biometric-based cryptographic key generation. The system enhances network authentication by eliminating the need for persistent storage of sensitive biometric data or private keys on devices or servers. The system generates cryptographic keys in real-time from biometric inputs to enhance computer network security. The system strengthens network authentication by removing storage requirements for biometric data and private keys from network devices and servers. The system creates reproducible cryptographic keys on-demand from biometric inputs to reduce attack surfaces by maintaining a zero-storage architecture between sessions. The system removes synchronization needs for biometric templates and credentials across network nodes to enhance scalability. The system streamlines network operations by decreasing storage needs, simplifying key management processes, and removing device credential synchronization requirements.

### 5. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

### 6. Harware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

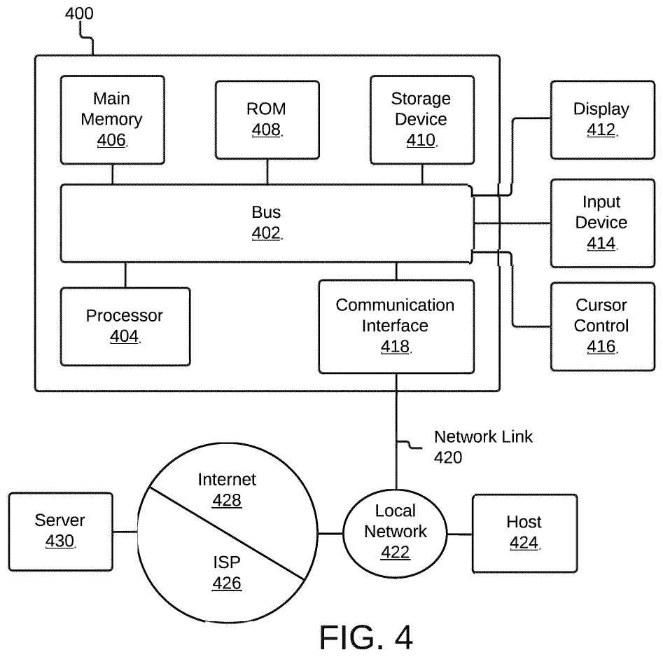

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

What is claimed is:

1. One or more non-transitory computer readable media comprising instructions that, when executed by one or more hardware processors, causes performance of operations comprising:
extracting, onto a first device, a first set of biometric data of a user;
applying a biometric-key process to the first set of biometric data to generate a first instance of a reproducible cryptographic key on the first device;
executing a first cryptographic operation using the first instance of the reproducible cryptographic key;
extracting, onto a second device, a second set of biometric data of the user;
applying the biometric-key process to the second set of biometric data to generate a second instance of the reproducible cryptographic key; and
executing a second cryptographic operation using the second instance of the reproducible cryptographic key.

2. The non-transitory media of claim 1, wherein applying the biometric-key process to the first set of biometric data to generate the first instance of the reproducible cryptographic key on the first device comprises:
generating a first user-specific feature vector from the first set of biometric data;
applying a process to the first user-specific feature vector, that is generated from the first set of biometric data, to generate the first instance of the reproducible cryptographic key on the first device.

3. The non-transitory media of claim 2, wherein generating the first user-specific feature vector comprises refining the first set of biometric data to extract facial features that remain substantially consistent over time.

4. The non-transitory media of claim 2, wherein generating the first user-specific feature vector includes a fuzzy extraction process.

5. The non-transitory media of claim 4, wherein the fuzzy extraction process uses a level of fuzziness based on a likelihood of change of user features.

6. The non-transitory media of claim 2, wherein applying the biometric-key process to the second set of biometric data to generate the first instance of the reproducible cryptographic key on the second device comprises:
generating a second user-specific feature vector from the first set of biometric data;
applying a process to the first user-specific feature vector, that is generated from the first set of biometric data, to generate the second instance of the reproducible cryptographic key.

7. The non-transitory media of claim 6, wherein the first user-specific feature vector and the second user-specific feature vector are identical, and the first set of biometric data and the second set of biometric data are not identical.

8. The non-transitory media of claim 6, wherein a same reproducible key generation process is used in the process to generate the reproducible cryptographic key from the first user-specific feature vector and the second user-specific feature vector.

9. The non-transitory media of claim 2, further comprising deleting the first set of biometric data and the first user-specific feature vector from the first device responsive at least to determining that execution of the first cryptographic operation is complete.

10. The non-transitory media of claim 2, wherein the first set of biometric data and the first user-specific feature vector from the first device are never written to persistent storage.

11. The non-transitory media of claim 1, further comprising, responsive to executing the first cryptographic operation, deleting the reproducible cryptographic key.

12. The non-transitory media of claim 1, wherein the reproducible cryptographic key comprises a private cryptographic key of a public-private key pair.

13. The non-transitory media of claim 1, wherein the operations further comprise:
extracting, onto a third device, a third set of biometric data of the user;
applying the biometric-key process to the third set of biometric data to generate a public-private key pair, wherein a private key of the public-private key pair is a third instance of the reproducible cryptographic key on the third device;
transmitting, to one or more servers, a public key of the public-private key pair for registration;
wherein the first cryptographic operation using the first instance of the reproducible cryptographic key comprises signing a message with the first instance of the reproducible cryptographic key.

14. The non-transitory media of claim 13, wherein the operations further comprise:
sending the message to the remote location; and
at the one or more servers, using the public key of the public-private key pair to authenticate the message.

15. The non-transitory media of claim 2, wherein the biometric-key process is an elliptic curve cryptography process that uses the first user-specific feature vector.

16. One or more transitory computer readable media comprising instructions that, when executed by one or more hardware processors, causes performance of operations comprising:
extracting, onto a device, a first set of biometric data from a user;
generating a user-specific feature vector from the first set of biometric data;
generating a cryptographic key from the user-specific feature vector;
executing a first operation using the cryptographic key; and
deleting the first set of biometric data from the device responsive to (a) determining that the user-specific feature vector has been generated from the first set of biometric data, (b) determining that the cryptographic key has been generated from the user-specific feature vector, or (c) the first operation using the cryptographic key has been executed.

17. The non-transitory media of claim 16, further comprising deleting the cryptographic key from the device responsive to determining that the first operation using the cryptographic key has been executed.

18. The non-transitory media of claim 16, wherein the first set of biometric data, first user-specific feature vector and the cryptographic key are never stored to persistent storage.

19. One or more transitory computer readable media comprising instructions that, when executed by one or more hardware processors, causes performance of operations comprising:
extracting, onto a device, a first set of biometric data from a user;
generating a user-specific feature vector from the first set of biometric data;
generating a cryptographic key from the user-specific feature vector;
executing a first operation using the cryptographic key; and
deleting the first set of biometric data from the device prior to (a) generating the user-specific feature vector from the first set of biometric data, (b) generating the cryptographic key from the user-specific feature vector, or (c) executing the first operation using the cryptographic key.

20. The non-transitory media of claim 19, further comprising deleting the cryptographic key from the device responsive to determining that the first operation using the cryptographic key has been executed.
